(19) United States
(12) Patent Application Publication
(10) Pub. No.: US 2010/0200400 A1
(43) Pub. Date: Aug. 12, 2010

(54) EMBEDDED BODILY FLUID ANALYSIS DEVICE

(75) Inventor: Frédéric REVOL-CAVALIER, Seyssins (FR)

Correspondence Address: OLIFF & BERRIDGE, PLC, P.O. BOX 320850, ALEXANDRIA, VA, 22320-4850, US

(73) Assignee: COMMISSARIAT A L'ENERGIE ATOMIQUE, Paris (FR)

(21) Appl. No.: 12/693,038

(22) Filed: Jan. 25, 2010

(30) Foreign Application Priority Data
Feb. 6, 2009 (FR) 09 00526

(51) Int. Cl. G01N 27/26

(52) U.S. Cl. 204/416; 204/435

(57) ABSTRACT

The invention relates to an embedded bodily fluid analysis device comprising a measuring cell containing the bodily fluid to be analyzed, at least one reference cell containing a reference standard and an electronic measuring circuit. The measuring cell is provided with at least one work electrode of the measuring cell and with at least one reference electrode of the measuring cell. The reference cell is provided with at least one work electrode of the reference cell formed by the same material or materials as a work electrode of the measuring cell and with at least one reference electrode of the reference cell formed by the same material or materials as a reference electrode of the measuring cell.

### BACKGROUND OF THE INVENTION

The invention relates to a bodily fluid analysis device that comprises:
a measuring cell containing the bodily fluid to be analyzed and provided with at least one work electrode of the measuring cell and with at least one reference electrode of the measuring cell,
at least one reference cell containing a reference standard and provided with at least one work electrode of the reference cell and with at least one reference electrode of the reference cell and,
an electronic measuring circuit connected to the work and reference electrodes of the measuring cell and of the reference cell.

### STATE OF THE ART

A large number of embedded devices for measuring physiological parameters of a person, for example heart rate or temperature, have been developed over the last few years to monitor the evolution of these parameters in particular for the purposes of monitoring the state of health of a person.

Bodily fluids such as sweat, saliva, tears, urine, blood, serum, plasma or interstitial liquid contain chemical, biochemical or biological molecules that provide information on the state of health of a person. Ions, proteins, enzymes and hormones are for example present in urine. Their concentration can vary in particular according to ingestion of medication, environmental parameters and the food ingested by the person.

In particular, physical-chemical analysis of sweat provides a great deal of information on the state of a person and can be used for diagnosing illnesses, for detecting poisonings or allergies. For example, the presence of xenobiotics such as pesticides, pollutants, medication or drugs can be detected by selective electrodes. These electrodes of the ion selective electrode (ISE) type react selectively to specific ions due to a sensitive layer that may be functionalized by a probe capable of complexing the specific ion. Likewise, mucoviscidosis can be diagnosed in infants by measuring the chlorine level in sweat. The variation of the ionic conductivity or of the electrical resistance of sweat, which is a function of the ionic concentration, provides information on the physiological modifications of a person. Dehydration of a sports person or a soldier can for example be monitored from the variation of the ionic conductivity of sweat proportional to the osmolarity. At present, the bodily fluid to be analyzed is collected beforehand on the person, for example by means of absorbent membranes in the form of a patch for sweat, and then analyzed at a later stage in a laboratory or by the person himself or herself. Certain bodily fluid analysis devices can in fact be used directly by the person himself and therefore make it possible to dispense with the presence of a clinician.

In particular the document WO99/35487 describes a bodily fluid analysis device for electrochemical or spectrophotometric measurement of the concentration of analytes in a bodily fluid, for example blood, saliva, urine and interstitial fluids. The device comes in the form of a test strip comprising a substrate with several compartments containing the bodily fluid to be analyzed and at least one compartment for a reference solution. The bodily fluid and reference solution are subjected to identical environmental conditions and the value obtained in real time is adjusted with respect to that of the reference solution. More particularly, an electrochemical test strip device having two separate compartments enables the glucose level in the blood to be dosed by differential measurement between the solution to be analyzed and a reference solution of known concentration. The glucose level is for example determined from the hydrogen peroxide released when the glucose reacts with various reagents. A probe such as ferrocene interacts with the hydrogen peroxide to produce a current proportional to the glucose level. This device enables a precise pin-point measurement to be made of a physical-chemical parameter of a bodily liquid, but is not suitable for continuous measurement enabling the evolution of a pathology or of a physiological phenomenon to be monitored.

### OBJECT OF THE INVENTION

The object of the invention is to propose a bodily fluid analysis device remedying the shortcomings of the prior art.

In particular, the object of the invention is to propose a bodily fluid analysis device enabling precise measurement of physical-chemical parameters of a bodily fluid to be made so as to monitor and check the physiological state of a person.

It is also an object of the invention to propose an embedded analysis device enabling continuous real-time measurements to be made directly on a person.

According to the invention, this object is achieved by the fact that the measuring cell has an inlet orifice and an outlet orifice of the bodily fluid, each orifice being connected to microfluidic draining means, and by the fact that the reference cell has two sealed-off orifices, and at least one work electrode of the reference cell formed by the same material or materials as a work electrode of the measuring cell, and at least one reference electrode of the reference cell formed by the same material or materials as a reference electrode of the measuring cell.

This object is also achieved by the fact that the work electrode of the reference cell and the reference electrode of the reference cell are respectively identical to the work electrode of the measuring cell and to the reference electrode of the measuring cell in size, shape, number and position.

According to a preferred embodiment, the reference cell has identical dimensions to those of the measuring cell.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 schematically represents a cross-section of particular embodiment of a bodily fluid analysis device according to the invention.

FIG. 2 schematically represents a cross-section of another particular embodiment of a bodily fluid analysis device according to the invention.

FIG. 3 schematically represents a top view of another particular embodiment of a bodily fluid analysis device according to the invention.

FIG. 4 represents three series of measurements made with a conductivity meter from a device according to the invention used for analyzing a person's sweat.

### DESCRIPTION OF PARTICULAR EMBODIMENTS OF THE INVENTION

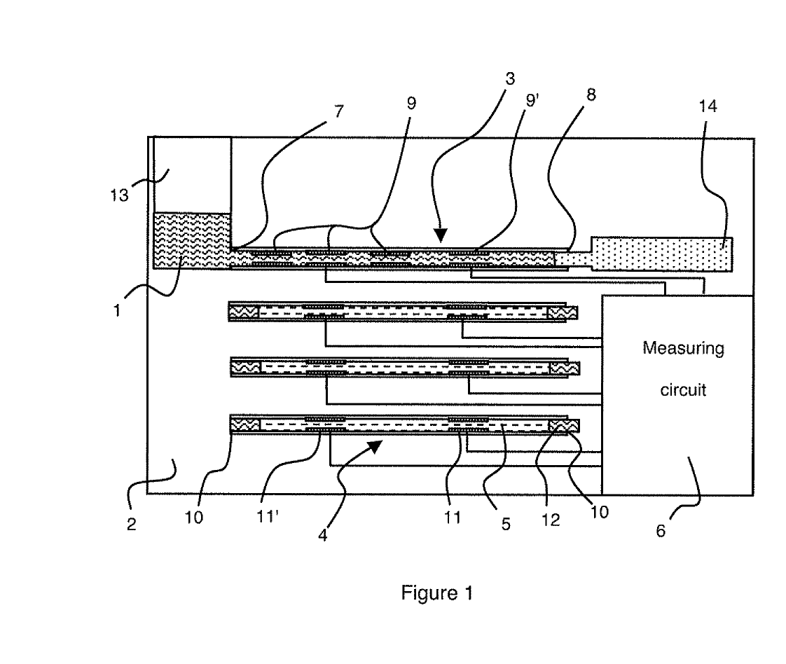

According to a particular embodiment represented in FIG. 1, the analysis device of a bodily fluid 1 comprises a support 2, a measuring cell 3 containing bodily fluid 1 to be analyzed and at least one reference cell 4 containing a reference standard 5. Support 2 is provided with at least the measuring cell 3. As represented in FIG. 1, support 2 is preferably provided with a measuring cell 3 and reference cells 4 so that cells 3 and 4 are fixed to support 2. Support 2 is in particular designed to position measuring cell 3 with respect to reference cells 4 and to hold measuring and reference cells, respectively 3 and 4, in place. The analysis device is preferably an embedded device, i.e. a portable device dedicated to analysis of bodily fluid 1 and comprising an electronic measuring circuit 6. Measuring circuit 6 can be on support 2 (FIG. 1) or it can be fixed to the outside of support 2.

Measuring cell 3 advantageously has a capillary structure and contains a preset volume of bodily fluid 1. What is meant by capillary structure is a hollow micro-tubular structure where a fluid movement can take place by capillarity. Measuring cell 3 has an inlet orifice 7 and an outlet orifice 8 of bodily fluid 1 and is provided with at least one work electrode 9 of the measuring cell and with at least one reference electrode 9′ of the measuring cell. The work and reference electrodes of the measuring cell, respectively 9 and 9′, are in contact with bodily fluid 1 and are arranged at a distance from one another along measuring cell 3. In FIG. 1, each work and reference electrode of the measuring cell, respectively 9 and 9′, is annular.

According to an alternative embodiment, work electrode 9 of the measuring cell and reference electrode 9′ of the measuring cell can have other surface geometries, for example cylindrical, in the form of a disk, a parallelepiped or a polygon.

According to a preferred embodiment, a reference cell 4 has identical dimensions to those of measuring cell 3. Likewise, each reference cell 4 can be identical to measuring cell 3, in particular in so far as the material or materials forming reference cell 4 and its structure, which is preferably capillary, are concerned.

According to an alternative embodiment, reference cell 4 is homothetic to measuring cell 3. The geometry of reference cell 4 has a similar shape to that of measuring cell 3. The angles and alignment of the geometrical points are kept but the distances between the points are larger or smaller.

Reference cell 4 contains reference standard 5. Reference standard 5 can be a liquid reference solution, a gel or a solid. For example purposes, reference standard 5 can be a polymer material containing ions in known concentration, or a silica-based material, a silicon nitride or a metallic material having a known electrical resistance. Reference standard 5 can also be formed from several layers of different insulating and conducting materials having a known resistance and/or capacitance. Reference cell 4 has two sealed-off orifices 10 and is provided with at least one work electrode of the reference cell 11 and at least one reference electrode of the reference cell 11′. Work electrode and reference electrode of the reference cell, respectively 11 and 11′, are in contact with reference standard 5. At least one of the orifices 10 of reference cell 4 is advantageously sealed off by a removable plug 12. Reference standard 5 can thereby be changed or renewed without having to remove reference cell 4 from the embedded analysis device.

Reference cell 4 has at least one work electrode 11 of the reference cell formed by the same material or materials as one work electrode 9 of the measuring cell. Likewise, reference cell 4 has at least one reference electrode 11′ of the reference cell formed by the same material or materials as one reference electrode 9′ of the measuring cell.

According to a particular embodiment, the embedded analysis device has several reference cells 4 each containing a reference standard 5 in the form of a solution containing a known concentration of a species, an analyte or a molecule. Simultaneous or consecutive measurement, for example of the conductivity of each reference standard solution 5 and of bodily fluid 1, enables a standard curve correlating the concentration of the species in the standard solutions and the conductivity to be drawn up. The value of the concentration of the species in bodily fluid 1 contained in measuring cell 3 is then determined from the conductivity result of bodily fluid 1 and from the standard curves.

The device can also enable the presence or absence of a species, such as a bacteria, a protein, sugar, a xenobiotic or an antibody contained in bodily fluid 1, to be detected. Measuring and reference cells, respectively 3 and 4, then comprise at least one electrode which reacts selectively to specific ions of ion selective electrode (ISE) type. This ion selective electrode is typically covered by a sensitive layer functionalized by a specific probe of the species to be detected, for example nucleic acids of natural or synthetic DNA type, proteins or enzymes.

According to a particular embodiment, at least one work electrode 9 of the measuring cell and at least one work electrode 11 of the reference cell is an ion selective electrode (ISE) which reacts selectively to specific ions. Recognition of the target species then results in a modification of the electric signal indicating the presence or absence of this target species.

According to an alternative embodiment, measuring and reference cells, respectively 3 and 4, can comprise more than two electrodes, for example three electrodes, with a work electrode, a reference electrode and a counter-electrode or an array of electrodes with a reference electrode and several ion selective electrodes (ISE), each being sensitive to a specific target species.

According to another particular embodiment, work and reference electrodes of the measuring cell, respectively 9 and 9′, and work and reference electrodes of the reference cell, respectively 11 and 11′, are metallic electrodes.

For example purposes, the bodily fluid analysis device represented in FIG. 1 consists of a measuring cell 3 and three reference cells 4. Measuring cell 3 is provided with four electrodes, a reference electrode 9′ of the measuring cell and three work electrodes 9 of the measuring cell, preferably of ISE type, each being formed by a different material and designed for measurement of a specific target species. Each reference cell 4 is provided with a reference electrode 11′ of the reference cell formed by the same material or materials as reference electrode 9′ of the measuring cell, and with a work electrode 11 of the reference cell formed by the same material as one of the three work electrodes 9 of the measuring cell. Each reference cell 4 thus measures a specific target species of reference standard 5. Measuring cell 3 enables measurements of the three specific target species to be made in bodily fluid 1.

According to an alternative embodiment, not represented, the analysis device can consist of a single reference cell 4 and several measuring cells 3. Each measuring cell 3 is then provided with a single work electrode 9 of the measuring cell to measure a single specific target species in bodily fluid 1. Reference cell 4 has several work electrodes 11 of the reference cell, each having the purpose of measuring a specific target species of reference standard 5.

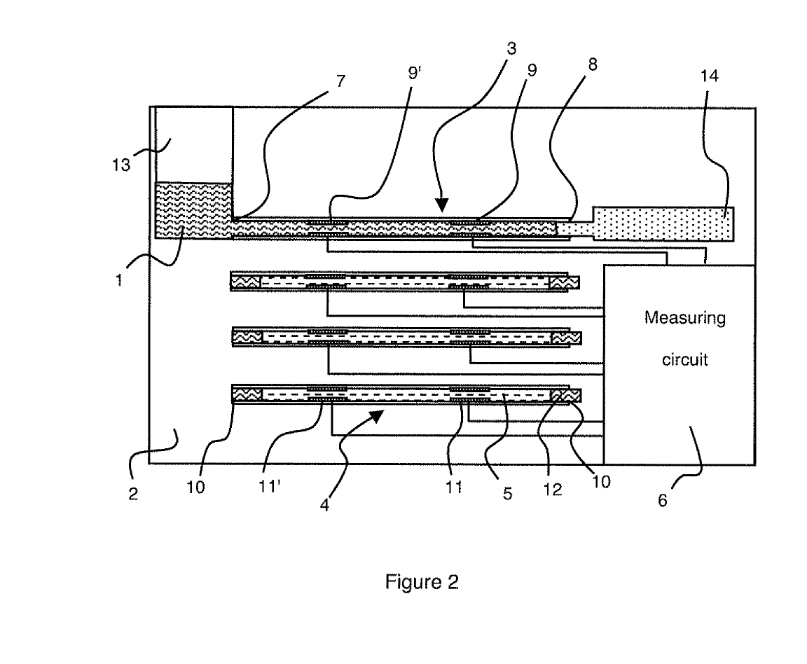

According to a preferred embodiment represented in FIG. 2, work electrode 11 of the reference cell and reference electrode 11′ of the reference cell are formed by the same material or materials as respectively work electrode 9 of the measuring cell and reference electrode 9′ of the measuring cell. Work electrode 11 of the reference cell and reference electrode 11′ of the reference cell are moreover identical respectively to work electrode 9 of the measuring cell and to reference electrode 9′ of the measuring cell in size, shape, number and position. Reference standard 5 is then subjected to the same conditions as those of bodily fluid 1.

Work and reference electrodes of the measuring cell, respectively, 9 and 9′, and work and reference electrodes of the reference cell, respectively 11 and 11′, are connected to electronic measuring circuit 6 to perform electrical and/or electrochemical measurements of bodily fluid 1 and of reference standard 5. To calibrate the measurements and to overcome the effect of variations due to the environmental parameters affecting measurement, a differential measurement is made between measuring cell 3 containing bodily fluid 1 and reference cell 4 containing reference standard 5. The values obtained for the bodily fluid 1 are readjusted according to those measured simultaneously or consecutively for reference standard 5.

The measurements can for example be measurements of electrical conductivity, capacitance, amperometry, chronoamperometric, potentiometric, voltamperometric and also mixed potential measurements. Support 2 can comprise one or more microcontrollers able to store the data and one or more wireless transceivers to communicate, for example by radiofrequency or infrared, with electronic measuring circuit 6 which may be at a distance from support 2. The information sought for, for example the concentration of a species in bodily fluid 1, can be displayed directly from processing of the measured current, voltage, resistance or impedance values. The directly displayed information can also be the presence or absence of a pathology or of a target species such as a protein.

The electrical or electrochemical measurements are sensitive to the environment in which they are made. Under real measurement conditions, in particular when the measurements are made directly on a person, a change of environment in which the person evolves will affect the electrical or electrochemical measurements. The latter are particularly sensitive to environmental parameters such as temperature, hygrometry or the nature of the materials of the electrodes used. Likewise, the shape of the electrodes and the distance between the electrodes will make the measurements vary. In order not to be affected by these environmental parameters, the electrical or electrochemical measurements are made from bodily fluid 1 contained in measuring cell 3 and, simultaneously or consecutively, on reference standard 5 contained in reference cell 4. The use of one or more reference cells 4 enables comparative measurements to be made between at least one reference standard 5, the chemical and/or physical characteristics of which are known, and bodily fluid 1 for which measurement is made.

Furthermore, for the same electrical and electrochemical measurement, a drift in time is often observed and generally requires calibration of the measuring or analysis device before each measurement. Differential measurement between measuring cell 3 and reference cell 4 also enables this drift to be eliminated. This feature is particularly interesting in the case of continuous measurements spaced in time.

Measuring cell 3 and reference cell 4 are advantageously capillary tubes formed by a material chosen from glass, molten silica and a polymer material. Glass and molten silica capillary tubes have an internal diameter preferably comprised between 20 μm and 700 μm and that of polymer material capillary tubes is between 100 μm and 1500 μm. The length of the capillary tube is preferably comprised between a few mm and 20 cm, more particularly between 5 mm and 5 cm.

Measuring cell 3 and reference cell 4 can advantageously be fixed, stuck or integrated on one and the same support 2. Support 2 is preferably formed by a flexible material that is inert with respect to bodily fluid 1 and to reference standard 5. It is preferably chosen from a synthetic, natural or artificial textile, a polymer material and a semiconducting material. For example purposes, support 2 is a fabric such as an item of clothing, a compress or a bandage on which measuring cell 3 and the reference cell or cells 4 are stuck. Support 2 can also be a rigid semiconducting material such as a silicon or germanium wafer sufficiently thinned to acquire the necessary flexibility for securing or integration thereof in a flexible support.

According to a preferred embodiment, support 2 is a fabric that is inert with respect to bodily fluid 1 and to reference standard 5. Measuring cell 3 and reference cell 4 form an integral part of support 2. The capillary structure of measuring and reference cells, respectively 3 and 4, is formed for example by the weaving of support 2.

The bodily fluid 1 to be analyzed can be collected directly on the person and then analyzed without prior processing, for example for sweat or saliva. In this case, the device can advantageously be carried by the user. In particular the embedded analysis device can be in contact with the person's skin to analyze sweat.

The bodily fluid 1 can also undergo processing before analysis. Plasma is for example obtained by prior centrifugation of the blood sample taken from the person and then analyzed punctually by the embedded analysis device which is not in this case carried by the person or in contact with the person.

Each inlet orifice 7 and outlet orifice 8 of measuring cell 3 is connected to microfluidic draining means which force bodily fluid 1 to flow from inlet orifice 7 to outlet orifice 8. The microfluidic draining means can be either active or passive. The microfluidic draining means are preferably formed by collecting means 13 of bodily fluid 1 connected to inlet orifice 7 of measuring cell 3 and a microfluidic pump 14 connected to outlet orifice 8 of measuring cell 3. The combined action of collecting means 13 and microfluidic pump 14 creates a draining phenomenon of bodily fluid 1 inside measuring cell 3.

Microfluidic pump 14 can for example be a vacuum pump constituting active microfluidic draining means. It can also be formed by an absorbent fabric integral to measuring cell 3 and blocking off outlet orifice 8, in this case constituting passive microfluidic draining means.

According to a particular embodiment represented in FIG. 2, the analysis device is in contact with a person's skin to analyze sweat. Collecting means 13 consist of a collect pocket of bodily fluid 1 fixed to support 2. The collect pocket enables bodily fluid 1 to be collected via an opening (not represented) in contact with the skin.

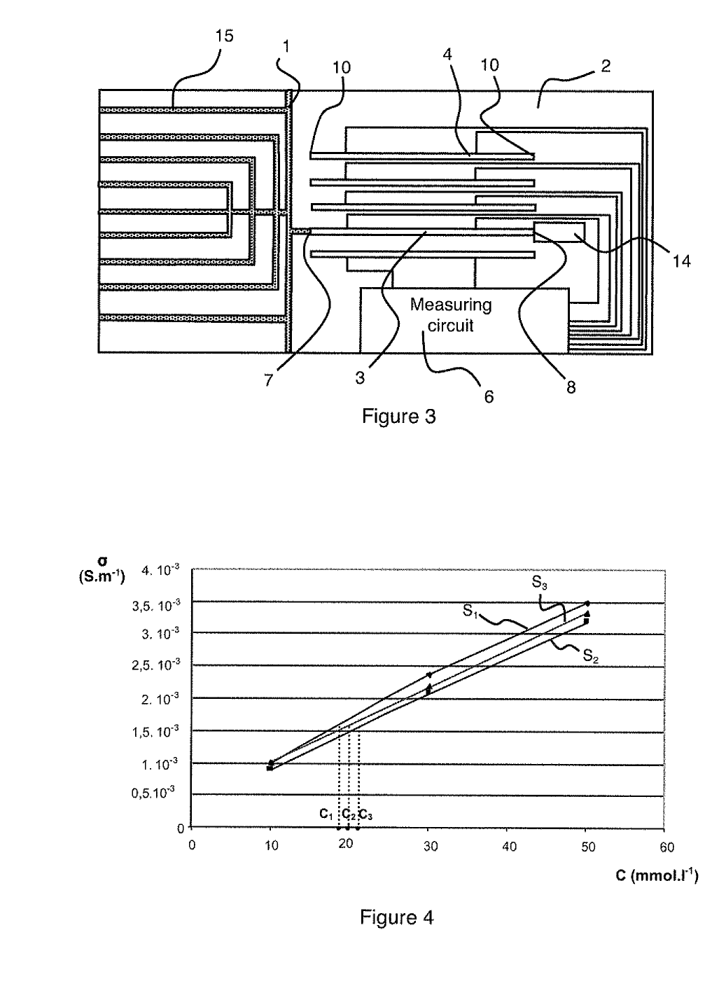

According to an alternative embodiment represented in FIG. 3, the analysis device, in contact with a person's skin to analyze his or her sweat, comprises a collecting means 13 consisting of a network of channels 15 integrated in support 2. An open part of channels 15 is then arranged facing the person's skin to collect sweat and to drain the latter off to measuring cell 3. Support 2 can for example be a fabric formed by hydrophilic parts in contact with the skin and hydrophobic parts. The hydrophilic and hydrophobic parts are arranged in such a way as to create the network of channels 15 that convey the sweat to measuring cell 3.

According to an alternative embodiment, not represented, the collecting means consist of a tube connected via one of its ends to measuring cell 3 and via its other end directly to the source generating bodily fluid 1. This source may be a mouth to collect saliva or a needle to collect blood.

For example purposes, conductivity metering measurements are made on a CDM 210 conductivity meter, marketed by Radiometer Analytical, from an embedded analysis device having a polyimide-base fabric support 2, for example with a base made from Kapton® or a polyethylene, for example polyethylene terephtalate (PET) or polyvinyl chloride (PVC). The embedded device comprises collecting means 13 formed by a pocket and a microfluidic pump 14 based on capillarity constituted by an absorbent fabric. The device also comprises a measuring cell 3 and three reference cells 4. Measuring cell 3 is provided with two metallic electrodes made from Platinum forming work electrode and reference electrode of the measuring cell, respectively 9 and 9′. Each of the reference cells 4 is provided with two Platinum metallic electrodes constituting work electrode and reference electrode of the reference cell, respectively 11 and 11′. The measurements are made on sweat collected on a person and three standard solutions 5 of sodium chloride respectively at a molar concentration of 10 mmol·l⁻¹, 30 mmol·l⁻¹, and 50 mmol·l⁻¹.

Each of the measuring and reference cells, respectively 3 and 4, consists of a tube with an internal diameter of 1 mm, and work electrode 9 of the measuring cell and work electrode 11 of the reference cell have a measuring surface of 2 mm². Three series of measurements are made with an interval of about 2 minutes between each series of measurements.

For each series of measurements, the conductivity value is recorded for the three standard solutions 5 and the sweat. In FIG. 4, three standard curve plots σ=f(C) representing the conductivity of the measured solutions versus the concentration are thereby obtained. Plots S₁, S₂ and S₃ correspond respectively to the first, second and third series of measurements. From these standard curves, three ionic concentrations of the sweat C₁, C₂ and C₃ can be determined with a value respectively of 19 mmol·l⁻¹, 20 mmol·l⁻¹ and 21 mmol·l⁻¹. These three values can be used to determine the concentration of the sweat, for example by taking the mean of these three values, or for monitoring the evolution of the concentration of the sweat versus time.

Unlike prior art methods, the embedded device for analyzing a bodily fluid 1 enables continuous and non-invasive real-time monitoring of physiological parameters to be performed from analysis of a bodily fluid 1. The measurements are also obtained by this device with a very great accuracy.

Although work electrodes 9 of the measuring cell and work electrodes 11 of the reference cell represented in the figures are in contact respectively with bodily fluid 1 and with reference standard 5, the invention is not limited to this type of electrodes. In particular, in the case of capacitive measurements, the electrodes can be arranged outside the capillaries.

Furthermore, although the examples given illustrate a device comprising a support 2, the invention is not limited to this type of device. The invention also covers an analysis device devoid of a support 2, the analysis device then being formed by measuring and reference cells, 3 and 4, arranged independently from one another.

1. A bodily fluid analysis device comprising:
a measuring cell containing the bodily fluid to be analyzed and provided with at least one work electrode of the measuring cell and at least one reference electrode of the measuring cell,
at least one reference cell containing a reference standard and provided with at least one work electrode of the reference cell and at least one reference electrode of the reference cell and,
an electronic measuring circuit connected to the work and reference electrodes of the measuring cell and of the reference cell,
a device wherein the measuring cell has an inlet orifice and an outlet orifice of the bodily fluid, each orifice being connected to microfluidic draining means, and the reference cell has two sealed-off orifices, and at least one work electrode of the reference cell formed by the same material or materials as a work electrode of the measuring cell, and at least one reference electrode of the reference cell formed by the same material or materials as a reference electrode of the measuring cell.

2. The device according to claim 1 comprising a support.

3. The device according to claim 1 wherein the work electrode of the reference cell and the reference electrode of the reference cell are respectively identical to the work electrode of the measuring cell and to the reference electrode of the measuring cell in size, shape, number and position.

4. The device according to claim 1 wherein the reference cell has identical dimensions to those of the measuring cell.

5. The device according to claim 1 wherein the measuring cell and the reference cell have a capillary structure.

6. The device according to claim 5 wherein the measuring cell and the reference cell are capillary tubes made from a material chosen from glass, molten silica and a polymer material.

7. The device according to claim 1 wherein the microfluidic draining means are formed by collecting means of the bodily fluid connected to the inlet orifice of the measuring cell and a microfluidic pump connected to the outlet orifice of the measuring cell.

8. The device according to claim 1 wherein the analysis device is in contact with a person's skin to analyze sweat, and the collecting means consist of a network of channels integrated in the support.

9. The device according to claim 1 wherein the analysis device is in contact with a person's skin to analyze sweat, and the collecting means consist of a collect pocket of the bodily fluid fixed to the support.

10. The device according to claim 1 wherein the microfluidic pump is formed by an absorbent fabric integral to the measuring cell and sealing off the outlet orifice.

11. The device according to claim 1 wherein at least one of the orifices of the reference cell is sealed off by a removable plug.

12. The device according to claim 1 wherein the support is formed by a flexible material.

13. The device according to claim 12 wherein the support is formed by a material chosen from a synthetic, natural or artificial textile, a polymer material and a semiconducting material.

14. The device according to claim 1 wherein the work and reference electrodes of the measuring cell and the work and reference electrodes of the reference cell are metallic electrodes.

15. The device according to claim 1 wherein at least one work electrode of the measuring cell and at least one work electrode of the reference cell is an ion selective electrode which reacts selectively to specific ions.

16. The device according to claim 1 wherein the reference standard is a liquid solution or a gel.

17. The device according to claim 1 wherein the reference standard is a solid standard.
